(19) United States
(12) Patent Application Publication
(10) Pub. No.: US 2019/0232950 A1
(43) Pub. Date: Aug. 1, 2019

(54) HYBRID POWERTRAIN SYSTEM

(71) Applicant: GM GLOBAL TECHNOLOGY OPERATIONS LLC, Detroit, MI (US)

(72) Inventors: Venkata Prasad Atluri, Novi, MI (US); Madhusudan Raghavan, West Bloomfield, MI (US); Neeraj S. Shidore, Novi, MI (US)

(73) Assignee: GM GLOBAL TECHNOLOGY OPERATIONS LLC, Detroit, MI (US)

(21) Appl. No.: 15/883,791

(22) Filed: Jan. 30, 2018

(51) Int. Cl. B60W 20/40; G05D 1/02; B60K 6/485; B60K 6/36; B60K 6/543; B60K 6/547; B60W 20/11; B60W 20/12; B60W 20/30; B60W 30/095; B60W 40/04; B60W 40/06

(52) U.S. Cl. CPC B60W 20/40; G05D 1/0223; B60K 6/485; B60K 6/36; B60K 6/543; B60K 6/547; H04W 4/46; B60W 20/12; B60W 20/30; B60W 30/0953; B60W 30/0956; B60W 40/04; B60W 40/06; B60W 20/11

(57) ABSTRACT

A powertrain system for a vehicle operates in one of a plurality of powertrain propulsion modes including an engine-only drive mode, an electric-only (EV) drive mode, a regenerative braking mode, a coasting mode and an engine/electric-assist mode. The vehicle also includes a Global Positioning System (GPS) sensor, a vehicle navigation system, a telematics system, a vehicle spatial monitoring system and a controller. The controller includes an instruction set that is executable to determine a trajectory for the vehicle, and determine road conditions, traffic conditions and surface conditions based upon the trajectory for the vehicle and the road conditions, traffic conditions and surface conditions. One of the powertrain propulsion modes is selected based upon the trajectory for the vehicle and the road conditions, traffic conditions and surface conditions. Operation of the hybrid powertrain system is controlled in the selected propulsion mode.

### BACKGROUND

Hybrid powertrain systems include internal combustion engines and electric motor/generators that are coupled to transmissions to transfer torque to a driveline for tractive effort. Electric motor/generators can deliver and/or be supplied electric power from energy storage systems. Powertrain systems may operate in various propulsion modes to generate and transfer propulsion power to vehicle wheels.

### SUMMARY

A vehicle is described and includes a hybrid powertrain system that is disposed to operate in one of a plurality of powertrain propulsion modes including an engine-only drive mode, an electric-only (EV) drive mode, a regenerative braking mode, a coasting mode and an engine/electric-assist mode. The vehicle also includes a Global Positioning System (GPS) sensor, a vehicle navigation system, a telematics system, a vehicle spatial monitoring system and a controller. The controller is in communication with the GPS, the vehicle navigation system, the telematics system and the vehicle spatial monitoring system, and is operatively connected to the hybrid powertrain system. The controller includes an instruction set that is executable to determine a trajectory for the vehicle, and determine road conditions, traffic conditions and surface conditions based upon the trajectory for the vehicle and the road conditions, traffic conditions and surface conditions. One of the powertrain propulsion modes is selected based upon the trajectory for the vehicle and the road conditions, traffic conditions and surface conditions. Operation of the hybrid powertrain system is controlled in the selected propulsion mode.

Another aspect of the disclosure includes the instruction set being executable to select one of the engine-only drive mode or the engine/electric-assist drive mode when traffic conditions include the vehicle entering a roundabout.

Another aspect of the disclosure includes the instruction set being executable to select one of the engine-only drive mode or the engine/electric-assist drive mode when traffic conditions include the vehicle operating in a left turn lane.

Another aspect of the disclosure includes the instruction set being executable to select one of the engine-only drive mode or the engine/electric-assist drive mode when traffic conditions include the vehicle operating in city traffic.

Another aspect of the disclosure includes the instruction set being executable to select the EV mode when traffic conditions include the vehicle operating on a limited access highway.

Another aspect of the disclosure includes the instruction set being executable to select the EV mode when traffic conditions include the vehicle operating on a two-lane highway.

Another aspect of the disclosure includes the instruction set being executable to select one of the engine-only drive mode or the engine/electric-assist drive mode when traffic conditions include the vehicle operating on an upward grade.

Another aspect of the disclosure includes the instruction set being executable to select one of the engine-only drive mode or the regenerative braking drive mode when traffic conditions include the vehicle operating on a downward grade.

Another aspect of the disclosure includes the instruction set being executable to select one of the engine-only drive mode or the regenerative braking drive mode when traffic conditions include the vehicle operating in an area having slow-moving vehicles.

Another aspect of the disclosure includes the instruction set being executable to select one of the engine-only drive mode or the regenerative braking drive mode when traffic conditions include the vehicle operating in an area having wet, snowy, or high wind conditions.

Another aspect of the disclosure includes the hybrid powertrain system including an internal combustion engine (engine), an electric machine and a transmission, wherein the torque converter is disposed between the engine and the input member of the transmission, wherein the engine is selectively coupled via a clutch to an input member of the transmission and wherein the electric machine is rotatably coupled to the input member of the transmission, wherein the transmission includes an output member coupled to a driveline of the vehicle and wherein the controller is operatively connected to the engine and the electric machine, wherein the controller includes an instruction set executable to control operation in one of the engine-only drive mode, the EV drive mode, the regenerative braking mode, the coasting mode and the engine/electric-assist mode.

Another aspect of the disclosure includes the electric machine including an electric motor/generator that is electrically connected to an inverter that is electrically connected to a DC power source, wherein the DC power source is configured to operate at a voltage level that is less than 60 V DC.

Another aspect of the disclosure includes the electric machine being rotatably coupled via an off-axis mechanical drive system to the input member of the transmission.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings.

FIG. 1 schematically illustrates a hybrid powertrain system that includes an internal combustion engine that is coupled to a transmission via an engine disconnect clutch and a torque converter, and an electrically-powered torque machine that is coupled to the transmission via an off-axis mechanical drive system, in accordance with the disclosure.

FIG. 2 schematically illustrates a propulsion mode selection routine for controlling operation of an embodiment of the hybrid powertrain system of FIG. 1, in accordance with the disclosure.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

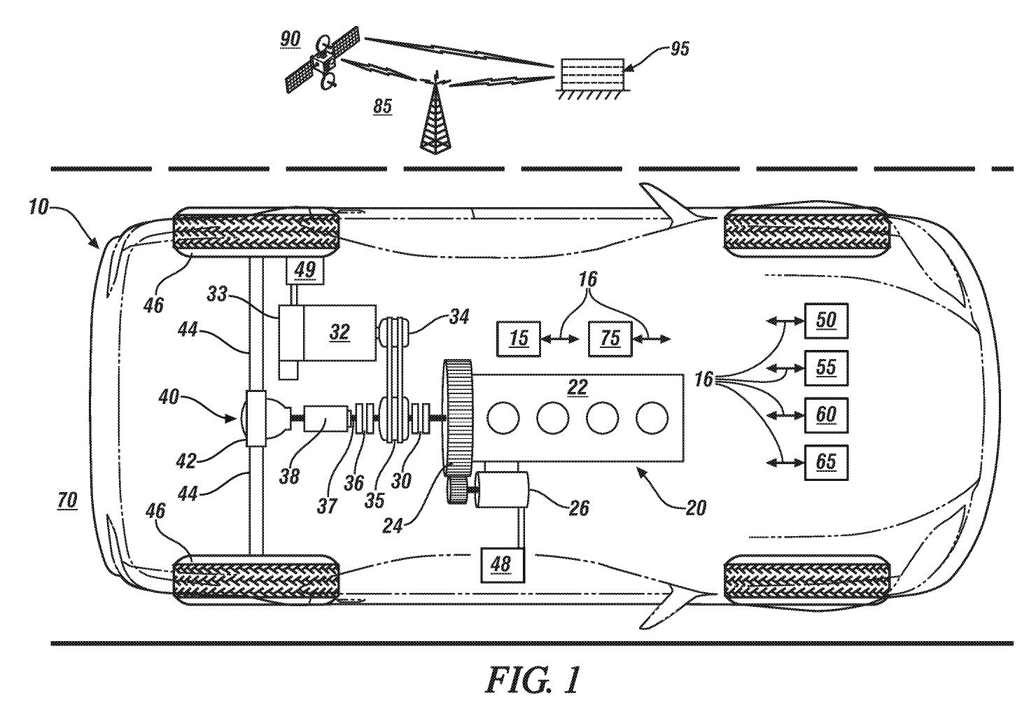

Referring now to the drawings, wherein the showings are for the purpose of illustrating certain exemplary embodiments only and not for the purpose of limiting the same, FIG. 1 schematically shows an embodiment of a vehicle 10 that is configured to operate on a roadway system 70 such as an intelligent vehicle highway system. The vehicle 10 advantageously includes a hybrid powertrain system (powertrain system) 20 and a plurality of controllers, including a Global Position System (GPS) sensor 50, a navigation system 55, a telematics device 60 and a spatial monitoring system 65.

The powertrain system 20 includes multiple torque-generating devices that are capable of generating and transferring torque via a transmission 38 to a driveline 40. The torque-generating devices include an internal combustion engine (engine) 22 and at least one electrically-powered motor/generator (electric machine) 32. The engine 22 and electric machine 32 are mechanically coupled to an input member 37 of the transmission 38 via an engine disconnect clutch 30, an off-axis mechanical drive system 34 and a torque converter 35 including a second clutch 36, to transfer propulsion power to vehicle wheels 46 via the driveline 40. The concepts described herein may apply to powertrain configurations that include the engine 22 and the electric machine 32 being disposed to transfer propulsion power to vehicle wheels 46 wherein the engine 22 can be selectively decoupled from the transmission 38 by deactivation of the engine disconnect clutch 30. The powertrain system 20 can be configured in a front-wheel drive arrangement, a rear-wheel drive arrangement or an all-wheel drive arrangement. Like numerals refer to like elements throughout the description. Operation of the powertrain system 20 may be controlled by a controller 15, which is shown as a unitary device for ease of illustration. The powertrain system 20 may be advantageously employed on a vehicle to provide propulsion power, and the vehicle may include, by way of non-limiting examples, a passenger vehicle, a light-duty or heavy-duty truck, a utility vehicle, an agricultural vehicle, an industrial/warehouse vehicle, a recreational off-road vehicle, aircraft, watercraft, train, all-terrain vehicle, personal movement apparatus, robot and the like to accomplish the purposes of this disclosure.

The engine 22 is configured as a multi-cylinder internal combustion engine that converts fuel to mechanical torque through a thermodynamic combustion process. The engine 22 is equipped with a plurality of actuators and sensing devices for monitoring operation and delivering fuel to form in-cylinder combustion charges that generate an expansion force onto pistons, with such force transferred to a crankshaft 12 to produce torque. The engine 22 includes a starter 26 that includes a low-voltage electric motor, a starter switch and a starter gear that meshingly engages gear teeth that are disposed on an outer circumference of a flywheel 24 that is coupled to the crankshaft of the engine 22 in one embodiment. The electric motor of the starter 26 can be configured, in one embodiment, as a single-phase electric motor including an output shaft that couples to the starter gear, wherein the single-phase electric motor is electrically connected to an accessory battery 48, or alternatively an ultracapacitor, via activation of the starter switch. In one embodiment, the starter gear is permanently meshingly engaged with the flywheel 24. Alternatively, the starter 26 can be another suitable configuration that includes a device and/or controller that is arranged to transfer torque to spin the engine crankshaft. The flywheel 24 also couples to an input member that is coupled via the engine disconnect clutch 30 to the off-axis mechanical drive 34. In one embodiment, the engine disconnect clutch 30 is a one-way clutch. In one embodiment, the one-way clutch is a selectable one-way clutch. Alternatively, the engine disconnect clutch 30 is configured as a hydraulic-actuated multi-plate friction clutch. Operation of the engine 22 including operation of the starter 26 is controlled by an engine controller, which may be integrated into or physically separated from the controller 15.

The engine 22 is mechanized with suitable hardware and the engine controller can include suitable control routines to execute autostart and autostop functions, fueled and fuel cutoff (FCO) functions, coasting, and all-cylinder and cylinder deactivation functions during ongoing operation of the powertrain 20. The engine 22 is considered to be in the OFF state when it is not rotating. The engine 22 is considered to be in an ON state when it is rotating. The all-cylinder state includes engine operation wherein all of the engine cylinders are activated by being fueled and fired. The cylinder deactivation state includes engine operation wherein one or a plurality of the engine cylinders are deactivated by being unfueled and unfired, and operating with engine exhaust valves in open states to minimize pumping losses, while the remaining cylinders are fueled and fired and thus producing torque. The ON state may include the FCO state in which the engine 22 is spinning and unfueled. The ON state may include the cylinder deactivation state. The ON state may include the FCO state in combination with the cylinder deactivation state. Engine mechanizations and control routines for executing autostart, autostop, FCO and cylinder deactivation control routines are known and not described herein. Engine operation may be described in context of engine states, including an engine operation state, an engine fueling state and an engine cylinder state. The engine operation states includes the ON and OFF states. The engine fueling states include the fueled state and the FCO state. The engine cylinder states include the all-cylinder state and the cylinder deactivation state.

The electric machine 32 can be a multi-phase electric motor/generator that is configured to convert stored electric energy to mechanical power for tractive effort and is also configured to convert mechanical power to electric energy that may be stored in a DC power source (traction battery) 49. The electric machine 32 is configured as a 15 kW device in one embodiment, and the traction battery 49 is configured to operate at a voltage level that is less than 60 V DC, and is set at a nominal 48V DC voltage level in one embodiment, or another DC voltage level. The electric machine 32 includes a rotor and a stator, and electrically connects via an inverter module 33 to the traction battery 49. The rotor couples to a rotatable member that couples to a motor pulley that is an element of the off-axis mechanical drive system 34.

The off-axis mechanical drive system 34 includes, in one embodiment, an outer pulley coupled to a pump of the torque converter 35, a motor pulley coupled to the rotor of the electric machine 32, and a continuous belt. The outer pulley and the motor pulley are rotatably coupled via the continuous belt to transfer torque therebetween. The outer pulley and the motor pulley may be configured with belt contact surfaces that are in the form of a single circumferential groove, multiple circumferential grooves, radial teeth, or another suitable arrangement, and the continuous belt is configured in accordance with the belt contact surfaces of the outer pulley and the motor pulley. In one embodiment, the off-axis mechanical drive system 34 includes a belt tensioner to ensure that the continuous belt makes contact with at least 180° of the belt contact surfaces of the outer pulley and the motor pulley. The continuous belt may be fabricated from Kevlar cords in one embodiment. In one embodiment, the pulley ratio between the outer pulley and the motor pulley is 2.5:1. Alternatively, the outer pulley and the motor pulley are rotatably coupled via a continuous chain to transfer torque therebetween. Alternatively, the outer pulley and the motor pulley are rotatably coupled via meshed gears to transfer torque therebetween.

The transmission 38 is a torque transfer device that includes, in one embodiment, a step-gear configuration composed of one or multiple differential gear sets and activatable clutches that are configured to effect torque transfer in one of a plurality of fixed gear states over a range of speed ratios between the engine 22, the input member 37 and an output member. In one non-limiting embodiment, the transmission 38 is configured as a nine-speed fixed-gear transmission. The transmission 38 may include a first rotational speed sensor in the form of a Hall-effect sensor or another suitable sensor that may be configured to monitor rotational speed of the input member 37 and/or a second rotational speed sensor that may be configured to monitor rotational speed of the output member. The transmission 38 includes an automatic transmission that automatically shifts between the fixed gear states to operate at a gear ratio that achieves a desired match between an output torque request and an engine operating point. The transmission 38 automatically executes upshifts to shift to a gear state having a lower numerical multiplication ratio (gear ratio) at preset speed/load points and executes downshifts to shift to a gear state having a higher numerical multiplication ratio at preset speed/load points. The transmission 38 may be controlled using a controllable hydraulic circuit that communicates with a transmission controller, which may be integrated into or separate from the controller 15. The transmission controller controls the torque converter clutch in one embodiment. The transmission 38 executes upshifts to shift to a fixed gear that has a lower numerical multiplication ratio (gear ratio) and executes downshifts to shift to a fixed gear that has a higher numerical multiplication ratio. A transmission upshift may require a reduction in engine speed so the engine speed matches transmission output speed multiplied by the gear ratio at a gear ratio associated with a target gear state. A transmission downshift may require an increase in engine speed so the engine speed matches transmission output speed multiplied by the gear ratio at a gear ratio associated with the target gear state. Transmission operation may be described in context of a control variable that may be communicated to the transmission 38 that is related to a selected fixed gear state. Alternatively, the transmission 38 may be a continuously-variable transmission device.

The driveline 40 may include a differential gear 42 that mechanically couples to axle(s) 44 that mechanically couples to wheel(s) 46 in one embodiment. The driveline 40 transfers tractive power between an output member of the transmission 38 and a road surface via the wheel(s) 46.

The inverter module 33 is configured with suitable control circuits including power transistors, e.g., integrated gate bipolar transistors (IGBTs) for transforming DC electric power to AC electric power and transforming AC electric power to DC electric power. The inverter module 33 may employ pulsewidth-modulating (PWM) control of the IGBTs to convert stored DC electric power originating in the traction battery 49 to AC electric power to drive the electric machine 32 to generate torque. Similarly, the inverter module 33 converts mechanical power transferred to the electric machine 32 to DC electric power to generate electric energy that is storable in the traction battery 49, including as part of a regenerative braking control strategy. The inverter module 33 receives motor control commands from the controller 15 and controls inverter states to provide a desired motor drive operation or a regenerative braking operation. In one embodiment, an auxiliary DC/DC electric power converter electrically connects to the bus and provides electric power to charge the accessory battery 48 via a low-voltage bus. The accessory battery 48 provides low-voltage electric power to low-voltage systems on the powertrain system 20 and the vehicle, including, e.g., the starter 26, electric windows, HVAC fans, seats, and other devices. In one embodiment the accessory battery 48 is configured to operate at a nominal 12V DC voltage level.

The traction battery 49 is disposed to supply electric power at a nominal voltage level of 48 V DC, and may be a DC power source, e.g., a multi-cell lithium ion device, an ultra-capacitor, or another suitable device without limitation. Monitored parameters related to the traction battery 49 may include a state of charge (SOC), temperature, and others. In one embodiment, the traction battery 49 may electrically connect via an on-vehicle battery charger to a remote, off-vehicle electric power source for charging while the vehicle is stationary.

The controller 15 may signally connect to an operator interface (not shown) and provides hierarchical control of a plurality of control devices to effect operational control of individual elements of the powertrain 20, including, e.g., the inverter module 33, the engine controller and the transmission controller. The controller 15 communicates with each of the inverter module 33, the engine controller and the transmission controller, via a communication link 16 to monitor operation and control operations thereof.

The powertrain system 20 is configured so that the engine 22 and the electric machine 32 are able to mechanically couple to the input member 37 of the transmission 38 employing the engine disconnect clutch 30, the torque converter 35, the second clutch 36 and the off-axis mechanical drive system 34. This enables the powertrain system 20 to operate in one of a plurality of selectable propulsion modes, including an engine-only drive mode, an electric-only (EV) drive mode, a regenerative braking mode, a coasting mode and an engine/electric-assist mode, which is also referred to as a hybrid mode. The configuration of the powertrain system 20 enables engine stop/start operations during powertrain system operation. The powertrain system 20 described herein advantageously employs the torque converter 35, which results in improved drivability during vehicle acceleration modes, transmission shifting modes and vehicle deceleration modes. Furthermore, the off-axis mechanical drive system 34 is configured to spin the electric machine 32 at a fixed speed ratio with regard to the engine speed, thereby eliminating need for an alternator to effect charging of the accessory battery 48. Furthermore, there is no need for an auxiliary electrically-powered hydraulic pump for the transmission 38 since the electric machine 32 is configured to and can be controlled to spin the torque converter 35 when the engine 22 is in an OFF state. The engine disconnect clutch 30 is disposed between the engine 22 and the transmission 38, which facilitates operation in the EV drive mode, the regenerative braking mode and an off-throttle vehicle sailing mode.

In the engine-only drive mode, the engine 22 is controlled to generate propulsion power while the electric machine 32 freewheels. The engine-only drive mode may be commanded during vehicle acceleration or steady-state running modes. In the EV drive mode, the electric machine 32 is controlled as a motor to generate propulsion power, while the engine 22 is in an OFF state and disconnected by deactivating the engine disconnect clutch 30. The EV drive mode may be commanded during idle, vehicle acceleration or steady-state running modes. In the regenerative mode, the electric machine 32 is controlled as a generator to react driveline torque and generate electric power, while the engine 22 is either at idle or in the OFF state and disconnected by deactivating the engine disconnect clutch 30. The regenerative mode may be commanded during coasting and vehicle braking. In the engine/electric-assist drive mode, the engine 22 and the electric machine 32 are controlled to generate propulsion power. The engine/electric-assist drive mode may be commanded during vehicle acceleration or steady-state running modes. In the coasting mode, the engine 22 is disconnected by deactivating the engine disconnect clutch 30, and the electric machine 32 is in a freewheel state.

The terms controller, control module, module, control, control unit, processor and similar terms refer to various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions, including monitoring inputs from sensing devices and other networked controllers and executing control and diagnostic routines to control operation of actuators. Routines may be periodically executed at regular intervals, or may be executed in response to occurrence of a triggering event. Communication between controllers, and communication between controllers, actuators and/or sensors may be accomplished using a direct wired link, a networked communications bus link, a wireless link, a serial peripheral interface bus or another suitable communications link, indicated herein as communication link 16. Communication includes exchanging data signals in suitable form, including, for example, electrical signals via a conductive medium, electromagnetic signals via air, optical signals via optical waveguides, and the like. Data signals may include signals representing inputs from sensors, signals representing actuator commands, and communications signals between controllers.

The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, a plurality of executable equations or another suitable form. A parameter is defined as a measurable quantity that represents a physical property of a device or other element that is discernible using one or more sensors and/or a physical model. A parameter can have a discrete value, e.g., either “1” or “0”, or can be infinitely variable in value.

The vehicle 10 includes a telematics device 60, which includes a wireless telematics communication system capable of extra-vehicle communications, including communicating with a communication network system having wireless and wired communication capabilities. The telematics device 60 is capable of extra-vehicle communications that includes short-range vehicle-to-vehicle (V2V) communication and/or vehicle-to-infrastructure (V2x) communication, which may include communication with an infrastructure monitor, e.g., a traffic camera. Alternatively or in addition, the telematics device 60 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics device 60, and the handheld device executes the extra-vehicle communication, including communicating with an off-board controller 95 via a communication network 90 via an antenna 85 or another communication mode. Alternatively or in addition, the telematics device 60 executes the extra-vehicle communication directly by communicating with the off-board controller 95 via the communication network 90.

The vehicle spatial monitoring system 65 includes a spatial monitoring controller in communication with a plurality of sensing devices. The vehicle spatial monitoring system 65 monitors and generates digital representations of remote objects proximate to the vehicle 10. The spatial monitoring system 65 can determine a linear range, relative speed, and trajectory of each proximate remote object. The sensing devices of the spatial monitoring system 65 may include, by way of non-limiting descriptions, front corner sensors, rear corner sensors, rear side sensors, side sensors, a front radar sensor, and a camera in one embodiment, although the disclosure is not so limited. Placement of the aforementioned sensors permits the spatial monitoring system 65 to monitor traffic flow including proximate vehicles and other objects around the vehicle 10. Data generated by the spatial monitoring system 65 may be employed by a lane mark detection processor (not shown) to estimate the roadway. The sensing devices of the vehicle spatial monitoring system 65 can further include object-locating sensing devices including range sensors, such as FM-CW (Frequency Modulated Continuous Wave) radars, pulse and FSK (Frequency Shift Keying) radars, and Lidar (Light Detection and Ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other camera/video image processors which utilize digital photographic methods to ‘view’ forward and/or rear objects including one or more object vehicle(s). Such sensing systems are employed for detecting and locating objects in automotive applications and are useable with systems including, e.g., adaptive cruise control, autonomous braking, autonomous steering and side-object detection.

The sensing devices associated with the spatial monitoring system 65 are preferably positioned within the vehicle 10 in relatively unobstructed positions. It is also appreciated that each of these sensors provides an estimate of actual location or condition of an object, wherein said estimate includes an estimated position and standard deviation. As such, sensory detection and measurement of object locations and conditions are typically referred to as ‘estimates.’ The characteristics of these sensors may be complementary, in that some are more reliable in estimating certain parameters than others. The sensing devices may have different operating ranges and angular coverages capable of estimating different parameters within their operating ranges. For example, radar sensors can usually estimate range, range rate and azimuth location of an object, but are not normally robust in estimating the extent of a detected object. A camera with vision processor is more robust in estimating a shape and azimuth position of the object, but is less efficient at estimating the range and range rate of an object. Scanning type lidar sensors perform efficiently and accurately with respect to estimating range, and azimuth position, but typically cannot estimate range rate, and are therefore not as accurate with respect to new object acquisition/recognition. Ultrasonic sensors are capable of estimating range but are generally incapable of estimating or computing range rate and azimuth position. Further, it is appreciated that the performance of each sensor technology is affected by differing environmental conditions. Thus, some of the sensing devices may present parametric variances during operation, although overlapping coverage areas of the sensors create opportunities for sensor data fusion.

The HMI system 75 provides for human/machine interaction, for purposes of directing operation of an infotainment system, the Global Positioning System (GPS) system, the vehicle navigation system, a remotely located service center and the like. The HMI system 75 monitors operator requests and provides information to the operator including status of vehicle systems, service and maintenance information. The HMI system 75 communicates with and/or controls operation of a plurality of in-vehicle operator interface device(s). The HMI system 75 may also communicate with one or more devices that monitor biometric data associated with the vehicle operator, including, e.g., eye gaze location, posture, and head position tracking, among others. The HMI system 75 is depicted as a unitary device for ease of description, but may be configured as a plurality of controllers and associated sensing devices in an embodiment of the system described herein. The in-vehicle operator interface device(s) 41 can include devices that are capable of transmitting a message urging operator action, and can include an electronic visual display module, e.g., a liquid crystal display (LCD) device, a heads-up display (HUD), an audio feedback device, a wearable device and a haptic seat.

Vehicle operation includes operation in one of the propulsion modes in response to desired commands, which can include operator requests and/or autonomous vehicle requests. Such operation includes acceleration, braking, steady-state running, coasting, and idling. Operator requests can be generated based upon operator inputs to an accelerator pedal, a brake pedal, a transmission range selector, and a cruise control system. Autonomous vehicle requests may be generated by an adaptive cruise control system, an autonomous braking/collision avoidance system and/or other systems that are configured to command and control autonomous vehicle operation separate from or in conjunction with the operator requests. Vehicle acceleration includes a tip-in event, which is a request to increase vehicle speed, i.e., accelerate the vehicle. A tip-in event can originate as an operator request for acceleration or as an autonomous vehicle request for acceleration. One non-limiting example of an autonomous vehicle request for acceleration can occur when a sensor for an adaptive cruise control system indicates that a vehicle can achieve a desired vehicle speed because an obstruction has been removed from a lane of travel, such as may occur when a slow-moving vehicle exits from a limited access highway. Braking includes an operator request to decrease vehicle speed. Steady-state running includes vehicle operation wherein the vehicle is presently moving at a rate of speed with no operator request for either braking or accelerating, with the vehicle speed determined based upon the present vehicle speed and vehicle momentum, vehicle wind resistance and rolling resistance, and driveline inertial drag, or drag torque. Coasting includes vehicle operation wherein vehicle speed is above a minimum threshold speed and the operator request to the accelerator pedal is at a point that is less than required to maintain the present vehicle speed. Idle includes vehicle operation wherein vehicle speed is at or near zero.

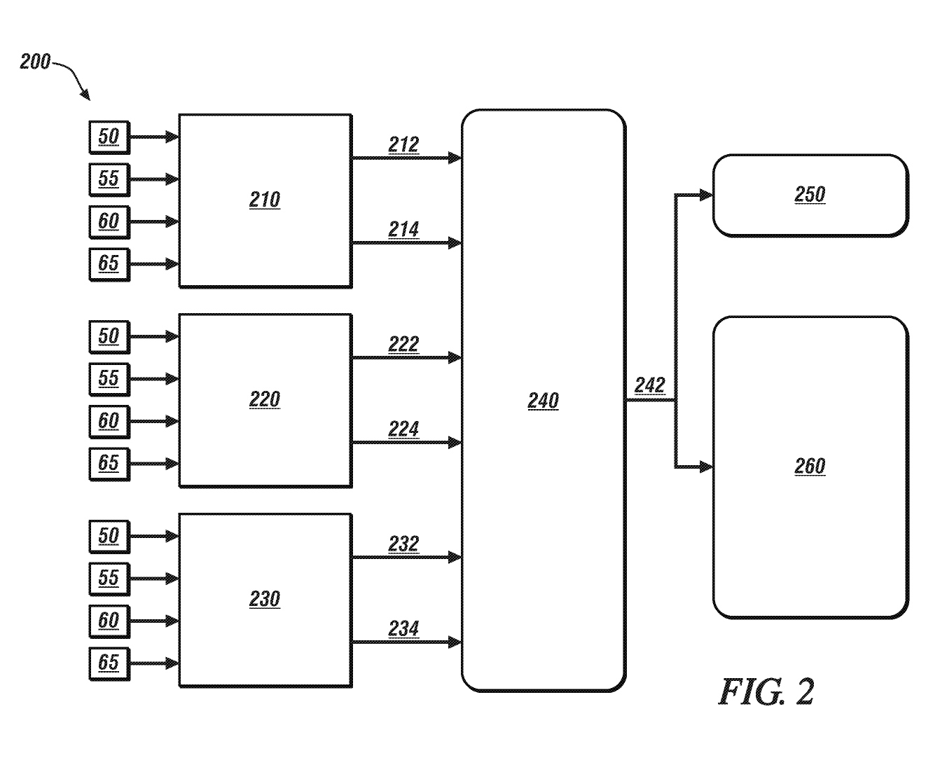

The controller 15 includes an instruction set that is executable to determine a trajectory for the vehicle 10, and determine present and/or impending road conditions and traffic conditions based upon the trajectory for the vehicle 10. One of the propulsion modes is selected based upon the trajectory for the vehicle and the road conditions and traffic conditions, and operation of the powertrain system 20 is controlled in the selected propulsion mode. This operation is described in detail with reference to a propulsion mode selection routine 200 shown in FIG. 2.

FIG. 2 schematically shows an embodiment of the propulsion mode selection routine 200 for controlling operation of an embodiment of the powertrain system 20 described with reference to FIG. 1. The routine 200 is exhibited as a flowchart, wherein the numerically labeled blocks and the corresponding functions are set forth as follows, corresponding to the propulsion mode selection routine 200. The teachings may be described herein in terms of functional and/or logical block components and/or various processing steps. It should be realized that such block components may be composed of hardware, software, and/or firmware components that have been configured to perform the specified functions. Execution of the propulsion mode selection routine 200 may proceed as follows. The steps of the routine 200 may be executed in a suitable order, and are not limited to the order described with reference to FIG. 2.

Elements of the propulsion mode selection routine 200 include a path planning step 210, a road load prediction step 220, a road condition monitoring step 230, an operating mode selection step 240 and propulsion mode implementation steps including a first propulsion mode 250 and a plurality of second propulsion modes 260. The GPS sensor 50, the navigation system 55, the telematics device 60 and the spatial monitoring system 65 generate signals and parameters that are communicated to the path planning step 210, the road load prediction step 220 and the road condition monitoring step 230. The aforementioned signals and parameters are dynamically determined and updated during vehicle operation.

The path planning step 210 monitors the inputs from the GPS sensor 50, the navigation system 55, the telematics device 60 and the spatial monitoring system 65 to discern details of the present and/or impending vehicle path associated with the trajectory of the vehicle 10. Such details can include determining a type of road, e.g., a city street, a limited access highway, a two-lane rural road, a left-turn lane, a round-about, or another road type. The path planning step 210 determines whether the present and/or impending vehicle path is a restricted path 212 or an unrestricted path 214. A restricted path 212 is defined as a travel path in which there is a high likelihood of a change that requires braking and subsequent acceleration, such as at an intersection or due to unfavorable road conditions, such as wet roads or other. An unrestricted path 214 is defined as a travel path in which there is minimal likelihood of a change that would require braking and/or acceleration. The output of a restricted path 212 or an unrestricted path 214 is provided as input to the operating mode selection step 240.

The road load prediction step 220 monitors the inputs from the GPS sensor 50, the navigation system 55, the telematics device 60 and the spatial monitoring system 65 to discern details of the present and/or impending vehicle path associated with the trajectory of the vehicle 10 that affect road load, i.e., may compel the vehicle operator to increase or decrease a vehicle demand for power. Such details can include determining presence of a road grade, either positive (uphill) or negative (downhill), detecting presence of another, slower-moving vehicle in the vehicle path, and detecting presence of a pedestrian, bicycle, or other slow-moving vehicle in the impending vehicle path or crossing the vehicle trajectory. The road load prediction step 220 determines whether the road load will be changing 222 or remain unchanged 224. The output of a changing road load 222 or an unchanging road load 224 is provided as input to the operating mode selection step 240.

The road condition monitoring step 230 monitors the inputs from the GPS sensor 50, the navigation system 55, the telematics device 60 and the spatial monitoring system 65 to discern details of the present and/or impending vehicle path associated with the trajectory of the vehicle 10 that affect road surface conditions, which may compel the vehicle operator to increase or decrease a vehicle demand for power. Such details can include determining road surface condition and weather conditions, specifically occurrence of inclement weather that may necessitate action by the vehicle operator to reduce vehicle speed to maintain traction. The road condition monitoring step 230 determines whether the impending road conditions will be default road conditions 232 or adjusted road conditions 234. The output of default road conditions 232 or adjusted road conditions 234 is provided as input to the operating mode selection step 240.

The operating mode selection step 240 monitors the inputs from the path planning step 210, the road load prediction step 220 and the road condition monitoring step 230 and selects one of the propulsion modes, i.e., one of the first propulsion mode 250 and the plurality of second propulsion modes 260 as a desired propulsion mode 242, and controls operation of the powertrain system 20 to achieve and operate in the desired propulsion mode 242.

The operating mode selection step 240 includes a plurality of rules by which it selects one of the first propulsion mode 250 and the plurality of second propulsion modes 260 as the desired propulsion mode 242. These rules include as follows, by way of non-limiting examples.

The first propulsion mode 250 is also referred to as an engine-only drive mode, which includes powertrain operation in which both the first and second clutches 30, 36 are activated, the engine 22 is operating in an all-cylinder state, and the electric machine 32 is freewheeling.

The second propulsion modes 260 include powertrain operation in which one or both the first and second clutches 30, 36 are deactivated, or the engine 22 is not operating in the all-cylinder state. The electric machine 32 may be freewheeling or operational. Examples of the second propulsion modes 260 include the EV drive mode, the regenerative braking mode, the coasting mode, and the engine/electric-assist mode.

When the vehicle 10 is entering or in the vicinity of a roundabout, the operating mode selection step 240 commands operation in the engine-only drive mode, or alternatively, the engine/electric-assist drive mode.

When the vehicle 10 is in a left turn lane, the operating mode selection step 240 commands operation in the first propulsion mode 250, i.e., engine-only drive mode. Alternatively, the operating mode selection step 240 commands operation in the engine/electric-assist drive mode.

When the vehicle 10 is operating in city traffic with lots of stop and go, the operating mode selection step 240 commands operation in the first propulsion mode 250, i.e., engine-only drive mode. Alternatively, the operating mode selection step 240 commands operation in the engine/electric-assist drive mode.

When the vehicle 10 is operating in highway operation, with minimal traffic, the operating mode selection step 240 commands operation in the second propulsion mode 260, e.g., the EV drive mode. Alternatively, the operating mode selection step 240 commands operation in the engine/electric-assist drive mode.

When the vehicle 10 is operating on a single lane road, the operating mode selection step 240 commands operation in the first propulsion mode 250, i.e., engine-only drive mode to allow for rapid passing. Alternatively, the operating mode selection step 240 commands operation in the engine/electric-assist drive mode.

When the vehicle 10 is operating on a multi-lane road with minimal traffic, the operating mode selection step 240 commands operation in the second propulsion mode 260, e.g., the EV drive mode or alternatively, the engine/electric-assist drive mode.

When the vehicle 10 is operating on an upward grade, the operating mode selection step 240 commands operation in the first propulsion mode 250, i.e., engine-only drive mode. Alternatively, the operating mode selection step 240 commands operation in the engine/electric-assist drive mode or the regenerative braking mode.

When the vehicle 10 is operating with the vehicle ahead being in close proximity, the operating mode selection step 240 commands operation in the first propulsion mode 250, i.e., engine-only drive mode. Alternatively, the operating mode selection step 240 commands operation in the engine/electric-assist drive mode or the regenerative braking mode.

When the vehicle 10 is operating in a situation in which there is significant pedestrian traffic (like in a city driving situation), the operating mode selection step 240 commands operation in the first propulsion mode 250, i.e., engine-only drive mode. Alternatively, the operating mode selection step 240 commands operation in the engine/electric-assist drive mode or the regenerative braking mode.

When the vehicle 10 is operating with the road surface being slick or wet or snow-covered or icy, the operating mode selection step 240 commands operation in the engine-only drive mode, or alternatively, the engine/electric-assist drive mode or the regenerative braking mode.

When the vehicle 10 is operating in weather conditions that include wet, snowy, or high wind conditions, the operating mode selection step 240 commands operation in the engine-only drive mode, or alternatively, the engine/electric-assist drive mode or the regenerative braking mode.

When a fault occurs in one of the sensors of the vehicle spatial monitoring system 65, the vehicle 10 will be unable to monitor weather conditions or road surface conditions. In this instance, the operating mode selection step 240 commands operation in the engine-only drive mode, or alternatively, the engine/electric-assist drive mode or the regenerative braking mode.

The vehicle may be operating in one of a plurality of vehicle modes in response to an output torque request and/or an input from an autonomous control system, including e.g., acceleration, braking, steady-state running, coasting, and idling modes.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A vehicle, comprising:
a hybrid powertrain system disposed to operate in one of a plurality of propulsion modes including an engine-only drive mode, an electric-only (EV) drive mode, a regenerative braking mode, a coasting mode, and an engine/electric-assist mode;
a Global Positioning System (GPS) and a vehicle navigation system;
a telematics system;
a vehicle spatial monitoring system; and
a controller, in communication with the GPS, the vehicle navigation system, the telematics system and the vehicle spatial monitoring system, and the controller operatively connected to the hybrid powertrain system, wherein the controller includes an instruction set executable to:
determine a trajectory for the vehicle,
determine road conditions, traffic conditions and surface conditions based upon the trajectory for the vehicle,
select one of the propulsion modes as a desired propulsion mode based upon the trajectory for the vehicle and the road conditions, traffic conditions and surface conditions, and
control operation of the hybrid powertrain system in the desired propulsion mode.

2. The vehicle of claim 1, wherein the instruction set is executable to select one of the engine-only drive mode or the engine/electric-assist drive mode as the desired propulsion mode when the traffic conditions include the vehicle entering a roundabout.

3. The vehicle of claim 1, wherein the instruction set is executable to select one of the engine-only drive mode or the engine/electric-assist drive mode as the desired propulsion mode when the traffic conditions include the vehicle operating in a left turn lane.

4. The vehicle of claim 1, wherein the instruction set is executable to select one of the engine-only drive mode or the engine/electric-assist drive mode as the desired propulsion mode when the traffic conditions include the vehicle operating in city traffic.

5. The vehicle of claim 1, wherein the instruction set is executable to select the EV mode as the desired propulsion mode when the traffic conditions include the vehicle operating on a limited access highway.

6. The vehicle of claim 1, wherein the instruction set is executable to select the EV mode as the desired propulsion mode when the traffic conditions include the vehicle operating on a two-lane highway.

7. The vehicle of claim 1, wherein the instruction set is executable to select one of the engine-only drive mode or the engine/electric-assist drive mode as the desired propulsion mode when the traffic conditions include the vehicle operating on an upward grade.

8. The vehicle of claim 1, wherein the instruction set is executable to select one of the engine-only drive mode or the regenerative braking drive mode as the desired propulsion mode when the traffic conditions include the vehicle operating on a downward grade.

9. The vehicle of claim 1, wherein the instruction set is executable to select one of the engine-only drive mode or the regenerative braking drive mode as the desired propulsion mode when the traffic conditions include the vehicle operating in an area having slow-moving vehicles.

10. The vehicle of claim 1, wherein the instruction set is executable to select one of the engine-only drive mode or the regenerative braking drive mode as the desired propulsion mode when the traffic conditions include the vehicle operating in an area having wet, snowy, or high wind conditions.

11. The vehicle of claim 1, wherein the instruction set is executable to select one of the engine-only drive mode or the regenerative braking drive mode as the desired propulsion mode when a fault occurs in a sensor of the vehicle spatial monitoring system.

12. The vehicle of claim 1, wherein the hybrid powertrain system comprises an internal combustion engine (engine), an electric machine and a transmission;
wherein a torque converter is disposed between the engine and an input member of the transmission;
wherein the engine is selectively coupled via a clutch to the input member of the transmission and wherein the electric machine is rotatably coupled to the input member of the transmission;
wherein the transmission includes an output member coupled to a driveline of the vehicle; and
wherein the controller is operatively connected to the engine and the electric machine, wherein the controller includes another instruction set executable to control operation in one of the engine-only drive mode, the EV drive mode, the regenerative braking mode, the coasting mode and the engine/electric-assist mode.

13. The vehicle of claim 12, wherein the electric machine comprises an electric motor/generator that is electrically connected to an inverter that is electrically connected to a DC power source, wherein the DC power source is configured to operate at a voltage level that is less than 60 V DC.

14. The vehicle of claim 13, wherein the electric machine is rotatably coupled via an off-axis mechanical drive system to the input member of the transmission.

15. A vehicle, comprising:
a hybrid powertrain system including an internal combustion engine (engine), an electric machine and a transmission;
wherein the engine is selectively coupled via a first clutch to an off-axis mechanical drive system,
wherein the electric machine is rotatably coupled to an input member of the transmission via the off-axis mechanical drive system and a second clutch,
wherein the transmission includes an output member coupled to a driveline of the vehicle, and
wherein the hybrid powertrain system is disposed to operate in one of a plurality of propulsion modes including a first propulsion mode and a plurality of second propulsion modes by activation of the first and second clutches;
a Global Positioning System (GPS);
a vehicle navigation system;
a telematics system;
a vehicle spatial monitoring system; and
a controller, in communication with the GPS, the vehicle navigation system, the telematics system and the vehicle spatial monitoring system, and operatively connected to the hybrid powertrain system, wherein the controller includes an instruction set executable to:
determine a trajectory for the vehicle,
determine road conditions, traffic conditions and surface conditions based upon the trajectory for the vehicle,
select the first propulsion mode or one of the plurality of second propulsion modes as a desired propulsion mode based upon the trajectory for the vehicle and the road conditions, traffic conditions and surface conditions, and
control operation of the hybrid powertrain system in the desired propulsion mode.

16. The vehicle of claim 15, wherein the first propulsion mode comprises an engine-only drive mode including powertrain operation in which both the first and second clutches are activated, the engine is operating in an all-cylinder state, and the electric machine is freewheeling.

17. The vehicle of claim 16, wherein the second propulsion modes comprise powertrain operation in which one or both the first and second clutches are deactivated, or the engine is not operating in the all-cylinder state.

18. The vehicle of claim 17, wherein the second propulsion modes include an electric vehicle (EV) drive mode, a regenerative braking mode, a coasting mode, and an engine/electric-assist mode.
